(19) United States
(12) Patent Application Publication
(10) Pub. No.: US 2014/0184654 A1
(43) Pub. Date: Jul. 3, 2014

(54) METHOD OF PERFORMING A MULTI-TIME PROGRAMMABLE OPERATION, AND ORGANIC LIGHT EMITTING DISPLAY DEVICE EMPLOYING THE SAME

(71) Applicant: Hee-Chul LEE, Yongin-City (KR)

(72) Inventor: Hee-Chul LEE, Yongin-City (KR)

(21) Appl. No.: 13/927,216

(22) Filed: Jun. 26, 2013

(30) Foreign Application Priority Data
Dec. 28, 2012 (KR) 10-2012-0156324

(51) Int. Cl. G09G 3/20

(52) U.S. Cl. CPC G09G 3/2003
USPC 345/690; 345/84

(57) ABSTRACT

A method of performing a multi-time programmable (MTP) operation includes independently setting respective pixel gamma curves for respective pixel circuits, obtaining respective actual gamma curves, the obtaining of the respective actual gamma curves including performing tests based on the respective pixel gamma curves for the respective pixel circuits, and storing respective gamma offsets, the storing of the respective gamma offsets including comparing the respective actual gamma curves with a reference gamma curve for the respective pixel circuits.

### CROSS-REFERENCE TO RELATED APPLICATION

This application claims the benefit of and priority under 35 U.S.C. §119 to Korean Patent Application No. 10-2012-0156324, filed on Dec. 28, 2012, in the Korean Intellectual Property Office, and entitled: “METHOD OF PERFORMING A MULTI-TIME PROGRAMMABLE OPERATION, AND ORGANIC LIGHT EMITTING DISPLAY DEVICE EMPLOYING THE SAME,” which is incorporated by reference herein in its entirety.

### BACKGROUND

1. Field

Embodiments relate to a method of performing a multi-time programmable (MTP) operation, and an organic light emitting display device employing the same.

2. Description of the Related Art

Recently, an organic light emitting display device is widely used as a flat panel display device. As the organic light emitting display device is manufactured, an image quality of an end product (i.e., complete product) of the organic light emitting display device may not reach a target quality level because of deviations in a manufacturing process. In this case, the end product may be determined as a defective product, and the defective product may be discarded.

### SUMMARY

Embodiments are directed to a method of performing a multi-time programmable (MTP) operation, the method including independently setting respective pixel gamma curves for respective pixel circuits, obtaining respective actual gamma curves, the obtaining of the respective actual gamma curves including performing tests based on the respective pixel gamma curves for the respective pixel circuits, and storing respective gamma offsets, the storing of the respective gamma offsets including comparing the respective actual gamma curves with a reference gamma curve for the respective pixel circuits.

The respective pixel circuits may include a red color pixel circuit, a green color pixel circuit, and a blue color pixel circuit.

The independent setting of the respective pixel gamma curves may include obtaining respective temporary gamma curves, the obtaining of the respective temporary gamma curves including performing tests based on the reference gamma curve for the respective pixel circuits, calculating a red color MTP offset, a green color MTP offset, and a blue color MTP offset, the calculating of the red color MTP offset, the green color MTP offset, and the blue color MTP offset including comparing the respective temporary gamma curves with the reference gamma curve for the respective pixel circuits, and selecting one of first through eighth gamma curves as the respective pixel gamma curves based on the red color MTP offset, the green color MTP offset, and the blue color MTP offset for the respective pixel circuits.

The obtaining of the respective temporary gamma curves may include performing tests at predetermined reference gray-levels based on the reference gamma curve for the respective pixel circuits.

The respective pixel circuits may further include a white color pixel circuit.

The independent setting of the respective pixel gamma curves may include obtaining respective temporary gamma curves, the obtaining of the respective temporary gamma curves including performing tests based on the reference gamma curve for the respective pixel circuits, calculating a red color MTP offset, a green color MTP offset, a blue color MTP offset, and a white color MTP offset, the calculating of the red color MTP offset, the green color MTP offset, the blue color MTP offset, and the white color MTP offset including comparing the respective temporary gamma curves with the reference gamma curve for the respective pixel circuits, and selecting one of first through sixteenth gamma curves as the respective pixel gamma curves based on the red color MTP offset, the green color MTP offset, the blue color MTP offset, and the white color MTP offset for the respective pixel circuits.

The obtaining of the respective temporary gamma curves may include performing tests at predetermined reference gray-levels based on the reference gamma curve for the respective pixel circuits.

The obtaining of the respective actual gamma curves may include performing tests at predetermined reference gray-levels based on the respective pixel gamma curves for the respective pixel circuits.

The storing of the respective gamma offsets may include comparing the respective actual gamma curves with the reference gamma curve at the predetermined reference gray-levels for the respective pixel circuits.

The method may further include storing respective setting offsets, the storing of the respective setting offsets including comparing the respective pixel gamma curves with the reference gamma curve for the respective pixel circuits.

The respective setting offsets and the respective gamma offsets may be stored in an MTP memory device included in a driving integrated circuit (D-IC).

The respective setting offsets and the respective gamma offsets may be calculated at predetermined reference gray-levels for the respective pixel circuits.

Embodiments are also directed to an organic light emitting display device, including a display panel having a plurality of pixel circuits, a scan driving unit configured to provide a scan signal to the pixel circuits, a data driving unit configured to provide a data signal to the pixel circuits, a power unit configured to provide a high power voltage and a low power voltage to the pixel circuits, a multi-time programmable (MTP) processing unit configured to perform an MTP operation based on respective pixel gamma curves for the respective pixel circuits, the respective pixel gamma curves being selected among a plurality of gamma curves, and a timing control unit configured to control the scan driving unit, the data driving unit, the power unit, and the MTP processing unit.

The MTP processing unit may be located inside the data driving unit, or inside the timing control unit.

The MTP processing unit may independently set the respective pixel gamma curves for the respective pixel circuits, obtain respective actual gamma curves, the obtaining of the respective actual gamma curves including performing tests based on the respective pixel gamma curves for the respective pixel circuits, store respective gamma offsets, the storing of the respective gamma offsets including comparing the respective actual gamma curves with a reference gamma curve for the respective pixel circuits, and store respective setting offsets, the storing of the respective setting offsets including comparing the respective pixel gamma curves with the reference gamma curve for the respective pixel circuits.

The MTP processing unit may adjust the data signal based on the respective gamma offsets and the respective setting offsets for the respective pixel circuits.

The respective pixel circuits may include a red color pixel circuit, a green color pixel circuit, and a blue color pixel circuit.

The MTP processing unit may obtain respective temporary gamma curves, the obtaining of the respective temporary gamma curves including performing tests based on the reference gamma curve for the respective pixel circuits, calculate a red color MTP offset, a green color MTP offset, and a blue color MTP offset, the calculating of the red color MTP offset, the green color MTP offset, and the blue color MTP offset including comparing the respective temporary gamma curves with the reference gamma curve for the respective pixel circuits, and select one of first through eighth gamma curves as the respective pixel gamma curves based on the red color MTP offset, the green color MTP offset, and the blue color MTP offset for the respective pixel circuits.

The respective pixel circuits may further include a white color pixel circuit.

The MTP processing unit may obtain respective temporary gamma curves, the obtaining of the respective temporary gamma curves including performing tests based on the reference gamma curve for the respective pixel circuits, calculate a red color MTP offset, a green color MTP offset, a blue color MTP offset, and a white color MTP offset, the calculating of the red color MTP offset, the green color MTP offset, the blue color MTP offset, and the white color MTP offset including comparing the respective temporary gamma curves with the reference gamma curve for the respective pixel circuits, and select one of first through sixteenth gamma curves as the respective pixel gamma curves based on the red color MTP offset, the green color MTP offset, the blue color MTP offset, and the white color MTP offset for the respective pixel circuits.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of performing a multi-time programmable (MTP) operation according to example embodiments.

FIG. 2 is a diagram illustrating an example in which an MTP operation is performed on respective pixel circuits included in a display panel by a method illustrated in FIG. 1.

FIG. 3 is a graph illustrating an example in which an MTP operation is performed on respective pixel circuits based on a plurality of gamma curves by a method illustrated in FIG. 1.

FIG. 4 is a flow chart illustrating an example in which respective pixel gamma curves are independently set for respective pixel circuits by a method illustrated in FIG. 1.

FIG. 5 is a diagram illustrating an example in which respective pixel gamma curves are independently set for respective pixel circuits by a method illustrated in FIG. 1.

FIG. 6 is a flow chart illustrating another example in which respective pixel gamma curves are independently set for respective pixel circuits by a method illustrated in FIG. 1.

FIG. 7 is a diagram illustrating another example in which respective pixel gamma curves are independently set for respective pixel circuits by a method illustrated in FIG. 1.

FIG. 8 is a block diagram illustrating an organic light emitting display device according to example embodiments.

FIG. 9 is a block diagram illustrating an MTP processing unit included in an organic light emitting display device of FIG. 8.

FIG. 10 is a block diagram illustrating an organic light emitting display device according to example embodiments.

FIG. 11 is a block diagram illustrating an electronic device having an organic light emitting display device according to example embodiments.

FIG. 12 is a diagram illustrating an example in which an electronic device illustrated in FIG. 11 is implemented as a smart-phone.

### DETAILED DESCRIPTION OF THE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art. In the drawing figures, dimensions may be exaggerated for clarity of illustration. Like reference numerals refer to like elements throughout.

It will be understood that, although the terms first, second, third, etc., may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

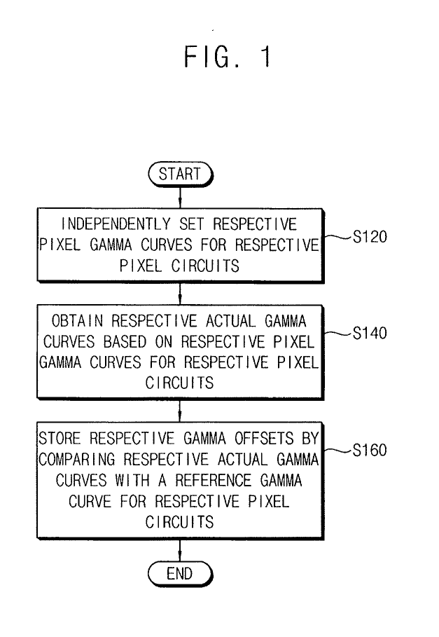

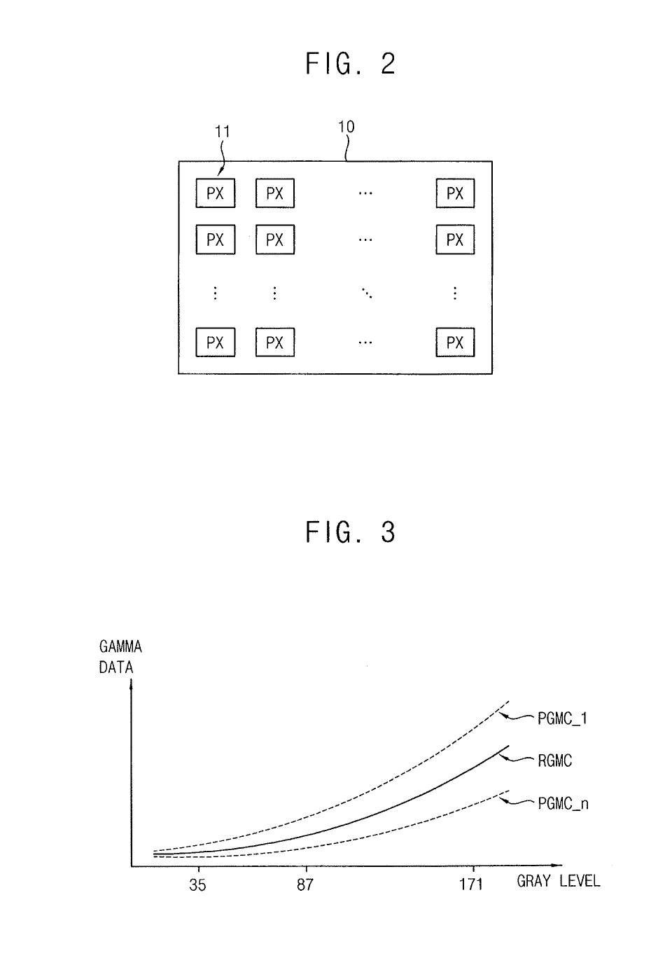

FIG. 1 is a flow chart illustrating a method of performing a multi-time programmable (MTP) operation according to example embodiments. FIG. 2 is a diagram illustrating an example in which an MTP operation is performed on respective pixel circuits included in a display panel by a method illustrated in FIG. 1. FIG. 3 is a graph illustrating an example in which an MTP operation is performed on respective pixel circuits based on a plurality of gamma curves by a method illustrated in FIG. 1.

Referring to the example embodiment shown in FIGS. 1 through 3, the method illustrated in FIG. 1 may independently set respective pixel gamma curves for respective pixel circuits 11 (operation S120), may obtain respective actual gamma curves, which may include performing tests based on the respective pixel gamma curves for the respective pixel circuits 11 (operation S140), and may store respective gamma offsets, which may include comparing the respective actual gamma curves with a reference gamma curve RGMC for the respective pixel circuits 11 (operation S160). In the present example embodiment, the respective pixel gamma curves indicate respective gamma curves that are selected by the respective pixel circuits 11 among a plurality of gamma curves in order to perform an MTP operation. In addition, the respective actual gamma curves indicate respective gamma curves that are obtained by performing tests on the respective pixel circuits 11 based on the respective pixel gamma curves. Further, the reference gamma curve RGMC indicates a gamma curve (e.g., GAMMA CURVE 2.2) that is set for displaying (i.e., outputting) an image in an organic light emitting display device.

Generally, an MTP operation for repeatedly performing a post-correction in luminance and color coordinate for the respective pixel circuits 11 of a display panel 10 is performed in order to adjust an image quality of the organic light emitting display device to reach a target quality level. To this end, the method illustrated in FIG. 1 may independently set the respective pixel gamma curves for the respective pixel circuits 11 (operation S120). Thus, the method illustrated in FIG. 1 may select one of first through (n)th gamma curves PGMC_1 through PGMC_n, where n is an integer greater than or equal to 2, as the respective pixel gamma curves for the respective pixel circuits 11. In the present example embodiment, the first through (n)th gamma curves PGMC_1 through PGMC_n correspond to candidates for the respective pixel gamma curves retained by the respective pixel circuits 11 in order to perform the MTP operation. For example, a first pixel circuit 11 may select (e.g., retain) the first gamma curve PGMC_1 as its pixel gamma curve, a second pixel circuit 11 may select the (n)th gamma curve PGMC_n as its pixel gamma curve, and a third pixel circuit 11 may select the first gamma curve PGMC_1 as its pixel gamma curve. Meanwhile, a quantity of the first through (n)th gamma curves PGMC_1 through PGMC_n may correspond to the number of cases related to MTP offsets. In addition, the first through (n)th gamma curves PGMC_1 through PGMC_n may be stored in gamma registers (e.g., referred to as gamma rooms) of a MTP memory device.

In an example embodiment, the respective pixel circuits 11 may include a red color pixel circuit (i.e., a pixel circuit representing a red color), a green color pixel circuit (i.e., a pixel circuit representing a green color), and a blue color pixel circuit (i.e., a pixel circuit representing a blue color). In this case, the method illustrated in FIG. 1 may obtain respective temporary gamma curves by performing tests based on the reference gamma curve RGMC for the respective pixel circuits 11, may calculate a red color MTP offset, a green color MTP offset, and a blue color MTP offset by comparing the respective temporary gamma curves with the reference gamma curve RGMC for the respective pixel circuits 11, and may select one of first through eighth gamma curves as the respective pixel gamma curves based on the red color MTP offset, the green color MTP offset, and the blue color MTP offset for the respective pixel circuits 11. In the present example embodiment, the respective temporary gamma curves indicate respective gamma curves that are obtained by performing tests based on the reference gamma curve RGMC for the respective pixel circuits 11. As described above, a quantity of the first through (n)th gamma curves PGMC_1 through PGMC_n may correspond to the number of cases related to MTP offsets. For example, when the MTP offsets include the red color MTP offset, the green color MTP offset, and the blue color MTP offset, the red color MTP offset may have a plus-value (i.e., +) or a minus-value (i.e., −) with respect to the reference gamma curve RGMC, the green color MTP offset may have a plus-value or a minus-value with respect to the reference gamma curve RGMC, and the blue color MTP offset may have a plus-value or a minus-value with respect to the reference gamma curve RGMC. Thus, a quantity of the first through (n)th gamma curves PGMC_1 through PGMC_n may be 8 (i.e., 2*2*2=8). Thus, an integer n may be 8. In example embodiments, the respective temporary gamma curves may be obtained by performing tests at predetermined reference gray-levels (e.g., 35 gray-level, 87 gray-level, and 171 gray-level) based on the reference gamma curve RGMC for the respective pixel circuits 11.

In another example embodiment, the respective pixel circuits 11 may include a red color pixel circuit (i.e., a pixel circuit representing a red color), a green color pixel circuit (i.e., a pixel circuit representing a green color), a blue color pixel circuit (i.e., a pixel circuit representing a blue color), and a white color pixel circuit (i.e., a pixel circuit representing a white color). In this case, the method illustrated in FIG. 1 may obtain respective temporary gamma curves by performing tests based on the reference gamma curve RGMC for the respective pixel circuits 11, may calculate a red color MTP offset, a green color MTP offset, a blue color MTP offset, and a white color MTP offset by comparing the respective temporary gamma curves with the reference gamma curve RGMC for the respective pixel circuits 11, and may select one of first through sixteenth gamma curves as the respective pixel gamma curves based on the red color MTP offset, the green color MTP offset, the blue color MTP offset, and the white color MTP offset for the respective pixel circuits 11. As described above, a quantity of the first through (n)th gamma curves PGMC_1 through PGMC_n may correspond to the number of cases related to MTP offsets. For example, when the MTP offsets include the red color MTP offset, the green color MTP offset, the blue color MTP offset, and the white color MTP offset, the red color MTP offset may have a plus-value or a minus-value with respect to the reference gamma curve RGMC, the green color MTP offset may have a plus-value or a minus-value with respect to the reference gamma curve RGMC, the blue color MTP offset may have a plus-value or a minus-value with respect to the reference gamma curve RGMC, and the white color MTP offset may have a plus-value or a minus-value with respect to the reference gamma curve RGMC. Thus, a quantity of the first through (n)th gamma curves PGMC_1 through PGMC_n may be 16 (i.e., 2*2*2*2=16). Thus, an integer n may be 16. In example embodiments, the respective temporary gamma curves may be obtained by performing tests at the predetermined reference gray-levels (e.g., 35 gray-level, 87 gray-level, and 171 gray-level) based on the reference gamma curve RGMC for the respective pixel circuits 11.

Next, the method illustrated in FIG. 1 may obtain the respective actual gamma curves by performing tests based on the respective pixel gamma curves for the respective pixel circuits 11 (operation S140). In the present example embodiment, the respective actual gamma curves may be different from the respective pixel gamma curves for the respective pixel circuits 11 because deviations may occur in a manufacturing process when the organic light emitting display device is manufactured. In example embodiments, the respective actual gamma curves may be obtained by performing tests at predetermined reference gray-levels (e.g., 35 gray-level, 87 gray-level, and 171 gray-level) based on the respective pixel gamma curves for the respective pixel circuits 11. As the respective actual gamma curves for the respective pixel circuits 11 are obtained, the method illustrated in FIG. 1 may store the respective gamma offsets by comparing the respective actual gamma curves with the reference gamma curve RGMC for the respective pixel circuits 11 (operation S160). In the present example embodiment, the respective gamma offsets may be stored by comparing the respective actual gamma curves with the reference gamma curve RGMC at the predetermined reference gray-levels (e.g., 35 gray-level, 87 gray-level, and 171 gray-level) for the respective pixel circuits 11. Since these are examples, a way of storing the respective gamma offsets is not limited thereto. Meanwhile, the method illustrated in FIG. 1 may store respective setting offsets by comparing the respective pixel gamma curves with the reference gamma curve RGMC for the respective pixel circuits 11. Similarly, the respective setting offsets may be stored by comparing the respective pixel gamma curves with the reference gamma curve RGMC at the predetermined reference gray-levels (e.g., 35 gray-level, 87 gray-level, and 171 gray-level) for the respective pixel circuits 11. Since these are examples, a way of storing the respective setting offsets is not limited thereto. In example embodiments, the respective gamma offsets and the respective setting offsets may be stored in the MTP memory device included in a driving integrated circuit (D-IC).

As described above, the method illustrated in FIG. 1 may perform the MTP operation in a wide range by independently setting the respective pixel gamma curves (i.e. selecting one of the first through (n)th gamma curves PGMC_1 through PGMC_n as the respective pixel gamma curves) for the respective pixel circuits, by generating the respective actual gamma curves based on the respective pixel gamma curves for the respective pixel circuits 11, and by comparing the respective actual gamma curves with the reference gamma curve RGMC to store the respective gamma offsets for the respective pixel circuits 11. In other words, since a general method performs the MTP operation based on a fixed pixel gamma curve for the respective pixel circuits 11, the MTP operation may not be performed if the respective gamma offsets has a value out of a predetermined range (e.g., 8 bits (−127˜128)). On the other hand, since the method illustrated in FIG. 1 performs the MTP operation based on the respective pixel gamma curves, where the respective pixel gamma curves are independently set for the respective pixel circuits 11, for the respective pixel circuits 11, the MTP operation may be performed regardless of a gamma offset range. As described above, the respective setting offsets between the respective pixel gamma curves and the reference gamma curve RGMC and the respective gamma offsets between the respective actual gamma curves and the reference gamma curve RGMC may be stored in the offset registers (e.g., referred to as the offset rooms) of the MTP memory device. Therefore, a data signal may be adjusted based on the respective gamma offsets and the respective setting offsets stored in the offset registers of the MTP memory device for the respective pixel circuits 11.

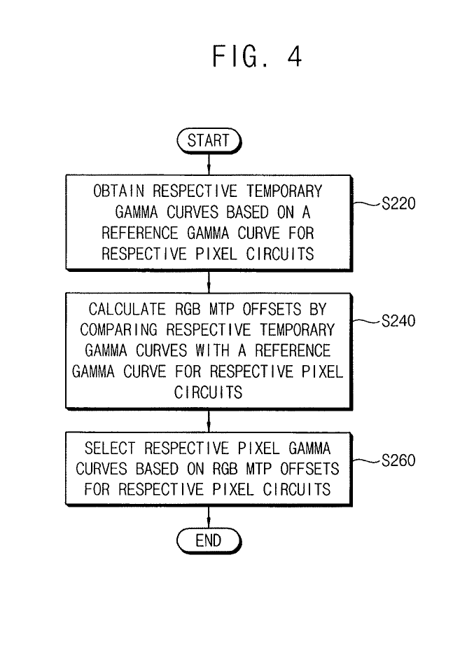

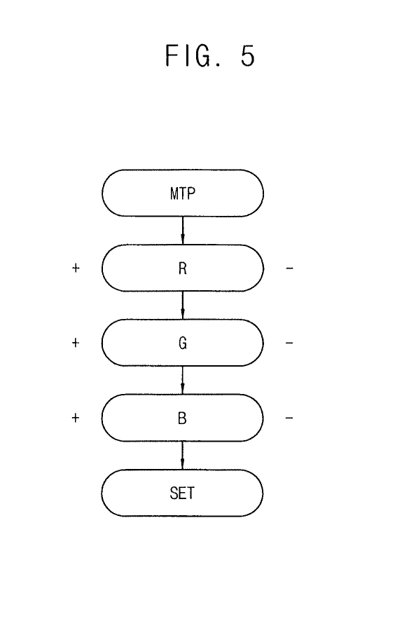

FIG. 4 is a flow chart illustrating an example in which respective pixel gamma curves are independently set for respective pixel circuits by a method illustrated in FIG. 1. FIG. 5 is a diagram illustrating an example in which respective pixel gamma curves are independently set for respective pixel circuits by a method illustrated in FIG. 1.

In the example embodiment show in FIGS. 4 and 5, it is illustrated that the respective pixel gamma curves are independently set for the respective pixel circuits 11 by the method illustrated in FIG. 1 when the respective pixel circuits 11 include a red color pixel circuit, a green color pixel circuit, and a blue color pixel circuit. Specifically, the method illustrated in FIG. 4 may obtain respective temporary gamma curves by performing tests based on a reference gamma curve RGMC for the respective pixel circuits 11 (operation S220), may calculate a red color MTP offset R, a green color MTP offset G, and a blue color MTP offset B by comparing the respective temporary gamma curves with the reference gamma curve RGMC for the respective pixel circuits 11 (operation S240), and may select one of first through eighth gamma curves PGMC_1 through PGMC_8 as the respective pixel gamma curves based on the red color MTP offset R, the green color MTP offset G, and the blue color MTP offset B for the respective pixel circuits 11 (operation S260). In example embodiments, the respective temporary gamma curves may be obtained by performing tests at predetermined reference gray-levels based on the reference gamma curve RGMC for the respective pixel circuits 11.

As illustrated in FIG. 5, the MTP offsets may include the red color MTP offset R, the green color MTP offset G, and the blue color MTP offset B. Thus, the red color MTP offset R may have a plus-value or a minus-value with respect to the reference gamma curve RGMC, the green color MTP offset G may have a plus-value or a minus-value with respect to the reference gamma curve RGMC, and the blue color MTP offset B may have a plus-value or a minus-value with respect to the reference gamma curve RGMC. Thus, one of the first through eighth gamma curves may be selected as the respective pixel gamma curves based on the red color MTP offset R, the green color MTP offset G, and the blue color MTP offset B for the respective pixel circuits 11. For example, one of the first through eighth gamma curves may be selected as the respective pixel gamma curves for the respective pixel circuits 11 using Table 1 below.

TABLE 1

| | | | | | | | | |
|---|---|---|---|---|---|---|---|---|
| R | + | + | + | + | − | − | − | − |
| G | + | + | − | − | + | + | − | − |
| B | + | − | + | − | + | − | + | − |
| PGC | GC1 | GC2 | GC3 | GC4 | GC5 | GC6 | GC7 | GC8 |

In the present example embodiment, PGC denotes the pixel gamma curve, and GC1 through GC8 denote the first through eighth gamma curves to be selected as the pixel gamma curve. Meanwhile, a quantity of the first through eighth gamma curves may correspond to the number of cases related to the MTP offsets. Thus, a quantity of the first through eighth gamma curves may be 8 (i.e., 2*2*2=8) because the red color MTP offset R has a plus-value or a minus-value with respect to the reference gamma curve RGMC, the green color MTP offset G has a plus-value or a minus-value with respect to the reference gamma curve RGMC, and the blue color MTP offset B has a plus-value or a minus-value with respect to the reference gamma curve RGMC. As described above, the method illustrated in FIG. 1 may independently set the respective pixel gamma curves (i.e., may select one of the first through eighth gamma curves as the respective pixel gamma curves) based on the red color MTP offset R, the green color MTP offset G, and the blue color MTP offset B for the respective pixel circuits 11 when the respective pixel circuits 11 include the red color pixel circuit, the green color pixel circuit, and the blue color pixel circuit. In example embodiments, the first through eighth gamma curves may be stored in gamma registers (i.e., referred to as gamma rooms) of an MTP memory device. Next, the method illustrated in FIG. 1 may generate the respective actual gamma curves based on the respective pixel gamma curves for the respective pixel circuits 11, and may store the respective gamma offsets by comparing the respective actual gamma curves with the reference gamma curve RGMC for the respective pixel circuits 11. As a result, the method illustrated in FIG. 1 may perform the MTP operation in a wide range.

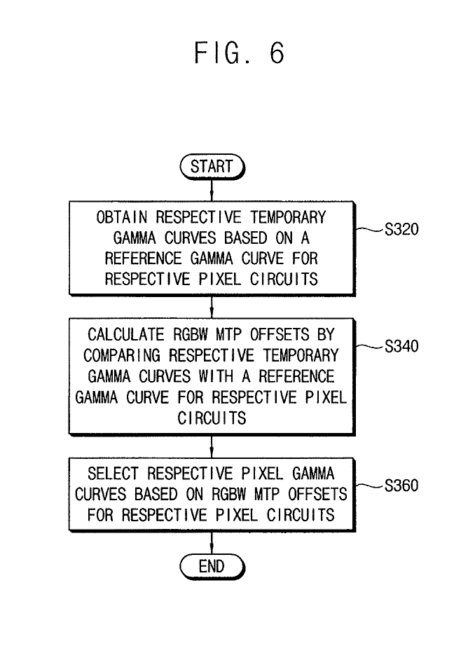

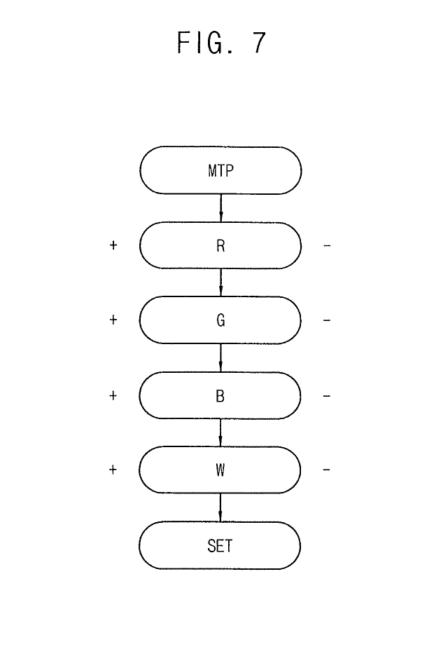

FIG. 6 is a flow chart illustrating another example in which respective pixel gamma curves are independently set for respective pixel circuits by the method illustrated in FIG. 1. FIG. 7 is a diagram illustrating another example in which respective pixel gamma curves are independently set for respective pixel circuits by the method illustrated in FIG. 1.

Referring to FIGS. 6 and 7, it is illustrated that the respective pixel gamma curves are independently set for the respective pixel circuits 11 by the method illustrated in FIG. 1 when the respective pixel circuits 11 include a red color pixel circuit, a green color pixel circuit, a blue color pixel circuit, and a white color pixel circuit. Specifically, the method illustrated in FIG. 1 may obtain respective temporary gamma curves by performing tests based on a reference gamma curve RGMC for the respective pixel circuits 11 (operation S320), may calculate a red color MTP offset R, a green color MTP offset G, a blue color MTP offset B, and a white color MTP offset W by comparing the respective temporary gamma curves with the reference gamma curve RGMC for the respective pixel circuits 11 (operation S340), and may select one of first through sixteenth gamma curves PGMC_1 through PGMC_16 as the respective pixel gamma curves based on the red color MTP offset R, the green color MTP offset G, the blue color MTP offset B, and the white color MTP offset W for the respective pixel circuits 11 (operation S360). In example embodiments, the respective temporary gamma curves may be obtained by performing tests at predetermined reference gray-levels based on the reference gamma curve RGMC for the respective pixel circuits 11.

As illustrated in FIG. 7, the MTP offsets may include the red color MTP offset R, the green color MTP offset G, the blue color MTP offset B, and the white color MTP offset W. Thus, the red color MTP offset R may have a plus-value or a minus-value with respect to the reference gamma curve RGMC, the green color MTP offset G may have a plus-value or a minus-value with respect to the reference gamma curve RGMC, the blue color MTP offset B may have a plus-value or a minus-value with respect to the reference gamma curve RGMC, and the white color MTP offset W may have a plus-value or a minus-value with respect to the reference gamma curve RGMC. Thus, one of the first through sixteenth gamma curves may be selected as the respective pixel gamma curves based on the red color MTP offset R, the green color MTP offset G, the blue color MTP offset B, and the white color MTP offset W for the respective pixel circuits 11. Meanwhile, a quantity of the first through sixteenth gamma curves may correspond to the number of cases related to the MTP offsets. Thus, a quantity of the first through sixteenth gamma curves may be 16 (i.e., 2*2*2*2=16) because the red color MTP offset R has a plus-value or a minus-value with respect to the reference gamma curve RGMC, the green color MTP offset G has a plus-value or a minus-value with respect to the reference gamma curve RGMC, the blue color MTP offset B has a plus-value or a minus-value with respect to the reference gamma curve RGMC, and the white color MTP offset W has a plus-value or a minus-value with respect to the reference gamma curve RGMC. As described above, the method illustrated in FIG. 1 may independently set the respective pixel gamma curves (i.e., may select one of the first through sixteenth gamma curves as the respective pixel gamma curves) based on the red color MTP offset R, the green color MTP offset G, the blue color MTP offset B, and the white color MTP offset W for the respective pixel circuits 11 when the respective pixel circuits 11 include the red color pixel circuit, the green color pixel circuit, the blue color pixel circuit, and the white color pixel circuit. In example embodiments, the first through sixteenth gamma curves may be stored in gamma registers (i.e., referred to as gamma rooms) of an MTP memory device. Next, the method illustrated in FIG. 1 may generate the respective actual gamma curves based on the respective pixel gamma curves for the respective pixel circuits 11, and may store the respective gamma offsets by comparing the respective actual gamma curves with the reference gamma curve RGMC for the respective pixel circuits 11. As a result, the method illustrated in FIG. 1 may perform the MTP operation in a wide range.

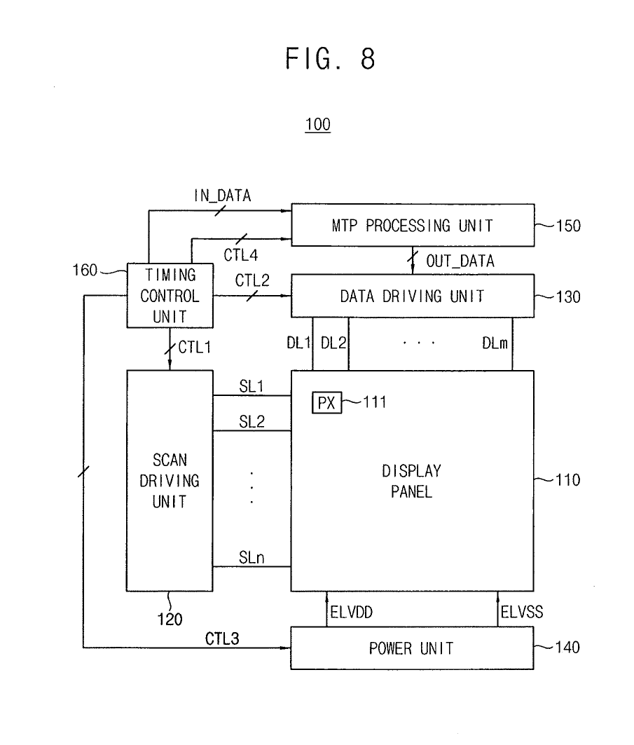

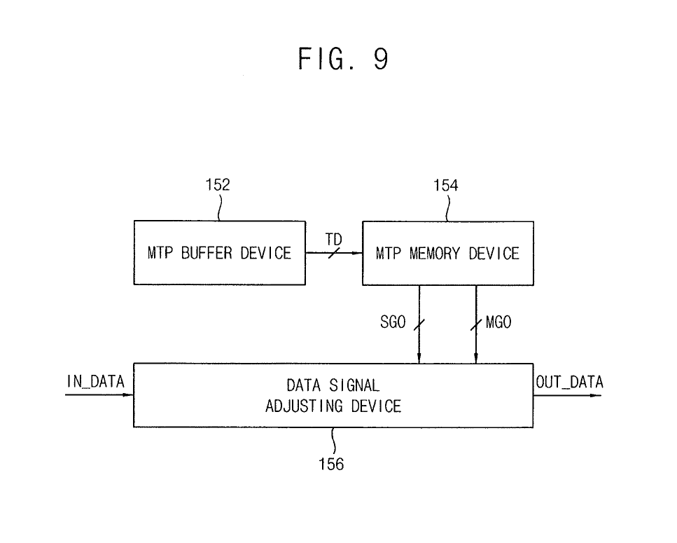

FIG. 8 is a block diagram illustrating an organic light emitting display device according to example embodiments. FIG. 9 is a block diagram illustrating an MTP processing unit included in an organic light emitting display device of FIG. 8.

In the example embodiment shown in FIGS. 8 and 9, the organic light emitting display device 100 may include a display panel 110, a scan driving unit 120, a data driving unit 130, a power unit 140, an MTP processing unit 150, and a timing control unit 160. For example, the organic light emitting display device 100 may employ a sequential emission driving technique.

The display panel 100 may include pixel circuits 111. The display panel 110 may be coupled to the scan driving unit 120 via scan-lines SL1 through SLn, and may be coupled to the data driving unit 130 via data-lines DL1 through DLm. In the present example embodiment, the display panel 110 may include n*m pixel circuits 111 because the pixel circuits are arranged at locations corresponding to crossing points of the scan-lines SL1 through SLn and the data-lines DL1 through DLm. In an example embodiment, the pixel circuits 111 may include red color pixel circuits, green color pixel circuits, and blue color pixel circuits. In another example embodiment, the pixel circuits 111 may include red color pixel circuits, green color pixel circuits, blue color pixel circuits, and white color pixel circuits. The scan driving unit 120 may provide a scan signal to the pixel circuits 111 via the scan-lines SL1 through SLn. The data driving unit 130 may provide a data signal to the pixel circuits 111 via the data-lines DL1 through DLm. The power unit 140 may provide a high power voltage ELVDD and a low power voltage ELVSS to the pixel circuits 111 via power-lines.

The MTP processing unit 150 may perform an MTP operation based on respective pixel gamma curves for respective pixel circuits 111. In the present example embodiment, one of first through (n)th gamma curves, where n is an integer greater than or equal to 2, may be selected as the respective pixel gamma curves for the respective pixel circuits 111. Specifically, the MTP processing unit 150 may independently set the respective pixel gamma curves for the respective pixel circuits 111, may obtain respective actual gamma curves by performing tests based on the respective pixel gamma curves for the respective pixel circuits 111, may store respective gamma offsets MGO by comparing the respective actual gamma curves with a reference gamma curve for the respective pixel circuits 111, and may store respective setting offsets SGO by comparing the respective pixel gamma curves with the reference gamma curve for the respective pixel circuits 111. Thus, when the organic light emitting display device 100 outputs an image, the MTP processing unit 150 may adjust the data signal (i.e., may convert an input data signal IN_DATA into an output data signal OUT_DATA) based on the respective gamma offsets MGO and the respective setting offsets SGO for the respective pixel circuits 111. As illustrated in FIG. 9, the MTP processing unit 150 may include an MTP buffer device 152, an MTP memory device 154, and a data signal adjusting device 156. Specifically, the MTP memory device 154 may receive data TD that are finally updated in the MTP buffer device 152 from the MTP buffer device 152, and may store the data TD as the respective gamma offsets MGO and the respective setting offsets SGO for the respective pixel circuits 111. In addition, the data signal adjusting device 156 may adjust the data signal based on the respective gamma offsets MGO and the respective setting offsets SGO for the respective pixel circuits 111. Since a structure of the MTP processing unit 150 is an example, the structure of the MTP processing unit 150 may be designed in various ways.

In an example embodiment, the respective pixel circuits 111 may include the red color pixel circuit, the green color pixel circuit, and the blue color pixel circuit. In this case, the MTP processing unit 150 may obtain respective temporary gamma curves by performing tests based on a reference gamma curve for the respective pixel circuits 111, may calculate a red color MTP offset, a green color MTP offset, and a blue color MTP offset by comparing the respective temporary gamma curves with the reference gamma curve for the respective pixel circuits 111, and may select one of first through eighth gamma curves as the respective pixel gamma curves based on the red color MTP offset, the green color MTP offset, and the blue color MTP offset for the respective pixel circuits 111. In another example embodiment, the respective pixel circuits 111 may include the red color pixel circuit, the green color pixel circuit, the blue color pixel circuit, and the white color pixel circuit. In this case, the MTP processing unit 150 may obtain respective temporary gamma curves by performing tests based on the reference gamma curve for the respective pixel circuits 111, may calculate a red color MTP offset, a green color MTP offset, a blue color MTP offset, and a white color MTP offset by comparing the respective temporary gamma curves with the reference gamma curve for the respective pixel circuits 111, and may select one of first through sixteenth gamma curves as the respective pixel gamma curves based on the red color MTP offset, the green color MTP offset, the blue color MTP offset, and the white color MTP offset for the respective pixel circuits 111. Since these are described referring to FIGS. 1 through 7, the duplicated descriptions will be omitted.

Referring again to FIG. 8, the timing control unit 160 may control the scan driving unit 120, the data driving unit 130, the power unit 140, and the MTP processing unit 150 based on the first through fourth control signals CTL1, CTL2, CTL3, and CTL4. Thus, the organic light emitting display device 100 may display (i.e., output) a high-quality image by performing the MTP operation in a wide range. In the present example embodiment, the organic light emitting display device 100 may perform the MTP operation in a wide range by independently setting the respective pixel gamma curves for the respective pixel circuits 111, by generating the respective actual gamma curves based on the respective pixel gamma curves for the respective pixel circuits 111, and by comparing the respective actual gamma curves with the reference gamma curve to store the respective gamma offsets MGO for the respective pixel circuits 111. In an example embodiment, as illustrated in FIG. 8, the MTP processing unit 150 may be located outside the timing control unit 160 and the data driving unit 130. In another example embodiment, the MTP processing unit 150 may be located inside the timing control unit 160, or inside the data driving unit 130.

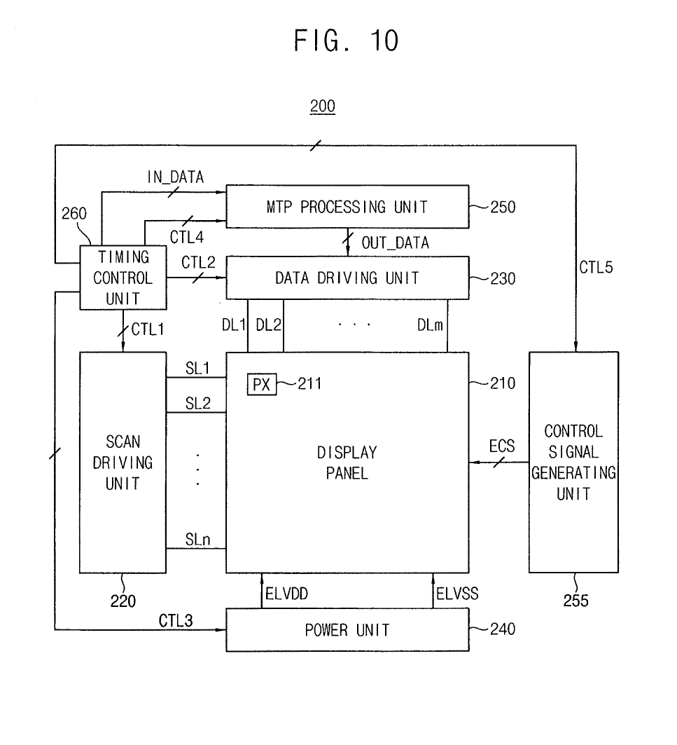

FIG. 10 is a block diagram illustrating an organic light emitting display device according to example embodiments.

In the example embodiment shown in FIG. 10, the organic light emitting display device 200 may include a display panel 210, a scan driving unit 220, a data driving unit 230, a power unit 240, an MTP processing unit 250, a control signal generating unit 255, and a timing control unit 260. For example, the organic light emitting display device 200 may employ a simultaneous emission driving technique.

The display panel 200 may include pixel circuits 211. The display panel 210 may be coupled to the scan driving unit 220 via scan-lines SL1 through SLn, and may be coupled to the data driving unit 230 via data-lines DL1 through DLm. In an example embodiment, the pixel circuits 211 may include red color pixel circuits, green color pixel circuits, and blue color pixel circuits. In another example embodiment, the pixel circuits 211 may include red color pixel circuits, green color pixel circuits, blue color pixel circuits, and white color pixel circuits. The scan driving unit 220 may provide a scan signal to the pixel circuits 211 via the scan-lines SL1 through SLn. The data driving unit 230 may provide a data signal to the pixel circuits 211 via the data-lines DL1 through DLm. The power unit 240 may provide a high power voltage ELVDD and a low power voltage ELVSS to the pixel circuits 211 via power-lines. The MTP processing unit 250 may perform an MTP operation based on respective pixel gamma curves for respective pixel circuits 211. In the present example embodiment, one of first through (n)th gamma curves, where n is an integer greater than or equal to 2, may be selected as the respective pixel gamma curves for the respective pixel circuits 211. In an example embodiment, as illustrated in FIG. 10, the MTP processing unit 250 may be located outside the timing control unit 260 and the data driving unit 230. In another example embodiment, the MTP processing unit 250 may be located inside the timing control unit 260, or inside the data driving unit 230. The control signal generating unit 255 may provide an emission control signal ECS to the display panel 210, where the emission control signal ECS controls the pixel circuits 211 of the display panel 210 to simultaneously emit light. The timing control unit 260 may control the scan driving unit 220, the data driving unit 230, the power unit 240, the MTP processing unit 250, and the control signal generating unit 255 based on first through fifth control signals CTL1, CTL2, CTL3, CTL4, and CTL5. Thus, the organic light emitting display device 200 may display (i.e., output) a high-quality image by performing the MTP operation in a wide range. In the present example embodiment, the organic light emitting display device 200 may perform the MTP operation in a wide range by independently setting the respective pixel gamma curves for the respective pixel circuits 211, by generating the respective actual gamma curves based on the respective pixel gamma curves for the respective pixel circuits 211, and by comparing the respective actual gamma curves with the reference gamma curve to store the respective gamma offsets for the respective pixel circuits 211.

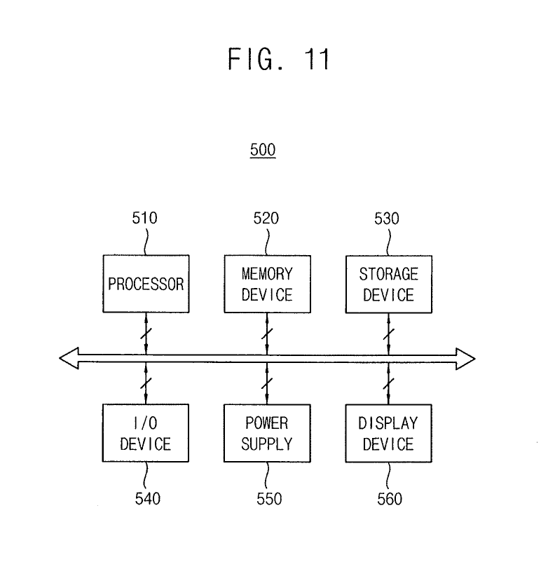

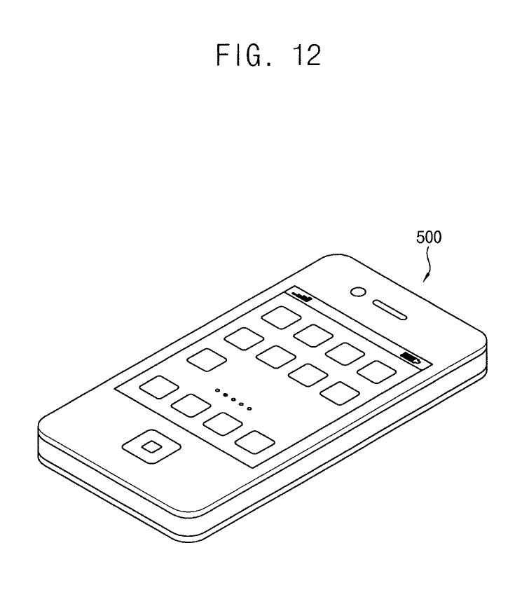

FIG. 11 is a block diagram illustrating an electronic device having an organic light emitting display device according to example embodiments. FIG. 12 is a diagram illustrating an example in which an electronic device illustrated in FIG. 11 is implemented as a smart-phone.

In the example embodiment shown in FIGS. 11 and 12, the electronic device 500 may include a processor 510, a memory device 520, a storage device 530, an input/output (I/O) device 540, a power supply 550, and an organic light emitting display device 560. In the present example embodiment, the organic light emitting display device 560 may correspond to the organic light emitting display device 100 of FIG. 8, or the organic light emitting display device 200 illustrated in FIG. 10. In addition, the electronic device 500 may further include a plurality of ports for communicating with a video card, a sound card, a memory card, a universal serial bus (USB) device, other electronic devices, etc. In an example embodiment, as illustrated in FIG. 12, the electronic device 500 may be implemented as the smart-phone. However, an implementation of the electronic device 500 is not limited thereto.

The processor 510 may perform various computing functions. The processor 510 may be a micro processor, a central processing unit (CPU), etc. The processor 510 may be coupled to other components via an address bus, a control bus, a data bus, etc. Further, the processor 510 may be coupled to an extended bus such as a peripheral component interconnection (PCI) bus. The memory device 520 may store data for operations of the electronic device 500. For example, the memory device 520 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc. The storage device 530 may be a solid state drive (SSD) device, a hard disk drive (HDD) device, a CD-ROM device, etc.

The I/O device 540 may be an input device such as a keyboard, a keypad, a touchpad, a touch-screen, a mouse, etc., and an output device such as a printer, a speaker, etc. In some example embodiments, the organic light emitting display device 560 may be included in the I/O device 540. The power supply 550 may provide a power for operations of the electronic device 500. The organic light emitting display device 560 may communicate with other components via the buses or other communication links. In an example embodiment, the organic light emitting display device 560 may include a display panel, a scan driving unit, a data driving unit, a power unit, an MTP processing unit, and a timing control unit. In another example embodiment, the organic light emitting display device 560 may include a display panel, a scan driving unit, a data driving unit, a power unit, an MTP processing unit, a control signal generating unit, and a timing control unit. In the present example embodiment, the MTP processing unit may perform an MTP operation based on one of first through (n)th gamma curves (i.e., respective pixel gamma curves) for respective pixel circuits of the display panel. Specifically, the MTP processing unit may independently set the respective pixel gamma curves for the respective pixel circuits, may obtain respective actual gamma curves by performing tests based on the respective pixel gamma curves for the respective pixel circuits, may store respective gamma offsets by comparing the respective actual gamma curves with a reference gamma curve for the respective pixel circuits, and may store respective setting offsets by comparing the respective pixel gamma curves with the reference gamma curve for the respective pixel circuits. Although it is described above that example embodiments are applied to the organic light emitting display device, embodiments may also be applied to a liquid crystal display (LCD) device.

Embodiments may be applied to an electronic device having a display device. For example, embodiments may be applied to a television, a computer monitor, a laptop, a digital camera, a cellular phone, a smart phone, a smart pad, a personal digital assistant (PDA), a portable multimedia player (PMP), an MP3 player, a navigation system, a game console, a video phone, etc.

By way of summation and review, discarding all end products determined as defective products is not efficient. Thus, a post-correction for adjusting the image quality of the organic light emitting display device to reach the target quality level may be considered. An MTP operation for repeatedly performing the post-correction in luminance and color coordinate for respective pixel circuits may be performed in order to adjust the image quality of the organic light emitting display device to reach the target quality level. Generally, the MTP operation may be performed by comparing an actual gamma curve, where the actual gamma curve is generated based on a pixel gamma curve, with a reference gamma curve to store respective gamma offsets. For example, the reference gamma curve may correspond to the pixel gamma curve. In this case, the actual gamma curve may be compared with the pixel gamma curve to store the respective gamma offsets. However, since general driving integrated circuit (D-IC) includes fixed gamma registers, the MTP operation may be performed by generating an actual gamma curve based on a fixed pixel gamma curve for the respective pixel circuits, and by comparing the actual gamma curve with a reference gamma curve to store the respective gamma offsets. As a result, it may be difficult to perform the MTP operation in a wide range. For example, the MTP operation may not be performed if the respective gamma offsets has a value out of a predetermined range (e.g., 8 bits (−127˜128)).

As described above, embodiments may provide a method of performing a multi-time programmable (MTP) operation capable of performing the MTP operation in a wide range when the MTP operation is performed on respective pixel circuits. Embodiments may provide an organic light emitting display device employing the method of performing the MTP operation. A method of performing an MTP operation according to example embodiments may perform the MTP operation in a wide range by independently setting respective pixel gamma curves for respective pixel circuits, and by comparing respective actual gamma curves, where the respective actual gamma curves are generated based on the respective pixel gamma curves, with a reference gamma curve to store respective gamma offsets for respective pixel circuits. In addition, an organic light emitting display device according to example embodiments may display (i.e., output) a high-quality image by employing the method of performing the MTP operation.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of performing a multi-time programmable (MTP) operation, the method comprising:
independently setting respective pixel gamma curves for respective pixel circuits;
obtaining respective actual gamma curves, the obtaining of the respective actual gamma curves including performing tests based on the respective pixel gamma curves for the respective pixel circuits; and
storing respective gamma offsets, the storing of the respective gamma offsets including comparing the respective actual gamma curves with a reference gamma curve for the respective pixel circuits.

2. The method of claim 1, wherein the respective pixel circuits include a red color pixel circuit, a green color pixel circuit, and a blue color pixel circuit.

3. The method of claim 2, wherein the independent setting of the respective pixel gamma curves includes:
obtaining respective temporary gamma curves, the obtaining of the respective temporary gamma curves including performing tests based on the reference gamma curve for the respective pixel circuits;
calculating a red color MTP offset, a green color MTP offset, and a blue color MTP offset, the calculating of the red color MTP offset, the green color MTP offset, and the blue color MTP offset including comparing the respective temporary gamma curves with the reference gamma curve for the respective pixel circuits; and
selecting one of first through eighth gamma curves as the respective pixel gamma curves based on the red color MTP offset, the green color MTP offset, and the blue color MTP offset for the respective pixel circuits.

4. The method of claim 3, wherein the obtaining of the respective temporary gamma curves includes performing tests at predetermined reference gray-levels based on the reference gamma curve for the respective pixel circuits.

5. The method of claim 2, wherein the respective pixel circuits further include a white color pixel circuit.

6. The method of claim 5, wherein the independent setting of the respective pixel gamma curves includes:
obtaining respective temporary gamma curves, the obtaining of the respective temporary gamma curves including performing tests based on the reference gamma curve for the respective pixel circuits;
calculating a red color MTP offset, a green color MTP offset, a blue color MTP offset, and a white color MTP offset, the calculating of the red color MTP offset, the green color MTP offset, the blue color MTP offset, and the white color MTP offset including comparing the respective temporary gamma curves with the reference gamma curve for the respective pixel circuits; and
selecting one of first through sixteenth gamma curves as the respective pixel gamma curves based on the red color MTP offset, the green color MTP offset, the blue color MTP offset, and the white color MTP offset for the respective pixel circuits.

7. The method of claim 6, wherein the obtaining of the respective temporary gamma curves includes performing tests at predetermined reference gray-levels based on the reference gamma curve for the respective pixel circuits.

8. The method of claim 1, wherein the obtaining of the respective actual gamma curves includes performing tests at predetermined reference gray-levels based on the respective pixel gamma curves for the respective pixel circuits.

9. The method of claim 8, wherein the storing of the respective gamma offsets includes comparing the respective actual gamma curves with the reference gamma curve at the predetermined reference gray-levels for the respective pixel circuits.

10. The method of claim 1, further comprising storing respective setting offsets, the storing of the respective setting offsets including comparing the respective pixel gamma curves with the reference gamma curve for the respective pixel circuits.

11. The method of claim 10, wherein the respective setting offsets and the respective gamma offsets are stored in an MTP memory device included in a driving integrated circuit (D-IC).

12. The method of claim 11, wherein the respective setting offsets and the respective gamma offsets are calculated at predetermined reference gray-levels for the respective pixel circuits.

13. An organic light emitting display device, comprising:
a display panel having a plurality of pixel circuits;
a scan driving unit configured to provide a scan signal to the pixel circuits;
a data driving unit configured to provide a data signal to the pixel circuits;
a power unit configured to provide a high power voltage and a low power voltage to the pixel circuits;
a multi-time programmable (MTP) processing unit configured to perform an MTP operation based on respective pixel gamma curves for the respective pixel circuits, the respective pixel gamma curves being selected among a plurality of gamma curves; and
a timing control unit configured to control the scan driving unit, the data driving unit, the power unit, and the MTP processing unit.

14. The device of claim 13, wherein the MTP processing unit is located inside the data driving unit, or inside the timing control unit.

15. The device of claim 14, wherein the MTP processing unit:
independently sets the respective pixel gamma curves for the respective pixel circuits,
obtains respective actual gamma curves, the obtaining of the respective actual gamma curves including performing tests based on the respective pixel gamma curves for the respective pixel circuits,
stores respective gamma offsets, the storing of the respective gamma offsets including comparing the respective actual gamma curves with a reference gamma curve for the respective pixel circuits, and
stores respective setting offsets, the storing of the respective setting offsets including comparing the respective pixel gamma curves with the reference gamma curve for the respective pixel circuits.

16. The device of claim 15, wherein the MTP processing unit adjusts the data signal based on the respective gamma offsets and the respective setting offsets for the respective pixel circuits.

17. The device of claim 13, wherein the respective pixel circuits include a red color pixel circuit, a green color pixel circuit, and a blue color pixel circuit.

18. The device of claim 17, wherein the MTP processing unit:
obtains respective temporary gamma curves, the obtaining of the respective temporary gamma curves including performing tests based on the reference gamma curve for the respective pixel circuits,
calculates a red color MTP offset, a green color MTP offset, and a blue color MTP offset, the calculating of the red color MTP offset, the green color MTP offset, and the blue color MTP offset including comparing the respective temporary gamma curves with the reference gamma curve for the respective pixel circuits, and
selects one of first through eighth gamma curves as the respective pixel gamma curves based on the red color MTP offset, the green color MTP offset, and the blue color MTP offset for the respective pixel circuits.

19. The device of claim 17, wherein the respective pixel circuits further include a white color pixel circuit.

20. The device of claim 19, wherein the MTP processing unit:
obtains respective temporary gamma curves, the obtaining of the respective temporary gamma curves including performing tests based on the reference gamma curve for the respective pixel circuits,
calculates a red color MTP offset, a green color MTP offset, a blue color MTP offset, and a white color MTP offset, the calculating of the red color MTP offset, the green color MTP offset, the blue color MTP offset, and the white color MTP offset including comparing the respective temporary gamma curves with the reference gamma curve for the respective pixel circuits, and
selects one of first through sixteenth gamma curves as the respective pixel gamma curves based on the red color MTP offset, the green color MTP offset, the blue color MTP offset, and the white color MTP offset for the respective pixel circuits.
